(19) United States
(12) Patent Application Publication
(10) Pub. No.: US 2007/0091375 A1
(43) Pub. Date: Apr. 26, 2007

(54) Optimum character string placing program

(75) Inventor: Shizuo Manabe, KITAKYUSHU (JP)

Correspondence Address: RADER FISHMAN & GRAUER PLLC, LION BUILDING, 1233 20TH STREET N.W., SUITE 501, WASHINGTON, DC, 20036, US

(73) Assignee: KABUSHIKI KAISHA GISKYUSHU, KITAKYUSHU (JP)

(21) Appl. No.: 10/578,000

(22) PCT Filed: Jul. 14, 2004
(86) PCT No.: PCT/JP04/10045

§ 371 Date: May 3, 2006

(51) Int. Cl. G06K 15/00

(52) U.S. Cl. 358/3.26; 358/1.18; 358/1.9

(57) ABSTRACT

An optimum character string placing program causes a computer to place a character string so as not to overlap another character string in a demarcated region. The program causes the computer to perform horizontal placement to place the character string along a prospective guide line that is located at the center of prospective guide lines that are longer than the longest horizontal segment of the area of the character string, the prospective guide lines being drawn as virtual horizontal lines at regular intervals in the demarcated region.

### BACKGROUND OF THE INVENTION

1. Field of the Invention

The present invention generally relates to an optimum character string placing program that causes a computer to place a character string so as not to overlap another character string in a demarcated region, and more particularly, to an optimum character string placing program for performing character string placement to promptly place a character string in such a manner that the character string can be easy to read and can look neat. Specific examples of demarcated regions include parcels of land that are defined through cadastral management and building areas on a map.

2. Description of the Related Art

A cadastral map that is output from a cadastral information managing system normally shows demarcated regions that are represented by parcels of land. In the demarcated regions, cadastral attributes are displayed as character strings. The cadastral attributes include location, lot number, land sections (parcels of land, unidentified lands, unnumbered long lots, lost lots), registered land category, taxable land category, registered area, taxable area, calculated area, owner information, co-owner information, tax payer, administrator, management of non-registered land, management of unidentified land, cadastral map number, scale and accuracy, registered date, title to the land, type of land usage, and items that can be managed separately (such as remarks). Conventionally, these character strings are inserted in demarcated regions manually. Alternatively, character strings are placed in the center of each demarcated region, and improperly placed character strings are then rearranged manually.

To counter this problem, Japanese Unexamined Patent Publication No. 2003-263101 discloses a method of placing character strings. This method is applied to a geographical information system that displays and prints the corresponding log number in the center of each parcel of land. The geographical information system includes: a storage unit that stores the vector data of the parcels of land and the lot number character string data corresponding to the parcels of land; and a control unit that arranges the lot number character strings in accordance with the parcel vector data stored in the storage unit. When the corresponding lot number character string is to be placed in a polygon that is formed by the parcel vector data stored in the storage unit, the control unit extracts the longest polygon segment of the horizontal scanning lines in the region of the parcel vector data, and place the lot number character string in the center of the vertical scanning line that intersects with the longest polygon segment. The control unit then determines whether the placed lot number character string can fit within the polygon, and moves the lot number character string horizontally and vertically, thereby detecting the location at which the lot number character string can fit within the polygon. With this structure, horizontal placement is performed to automatically adjust the location of a lot number character string and place the lot number character string within the boundaries of the corresponding parcel of land in a geographical information system that needs to display and print the lot number character strings corresponding to parcels of land.

By the above conventional method, each character string can be properly placed, while the location is automatically adjusted. However, placement is performed, with the longest segment being the reference. If the subject demarcated region has a circular shape having a segment of the same length as the longest segment in the vicinity of the longest segment, character string placement may be properly performed. On a real map, there are very few demarcated regions having such a shape, and character string placement cannot be properly performed. Also, by the above described conventional method, a lot number character string that can be placed cannot have two or more lines. Because of these facts, the conventional method has the problem that a character string that forms a rectangular shape can be placed, but two or more character strings that form a polygonal shape cannot be properly placed.

### SUMMARY OF THE INVENTION

It is therefore an object of the present invention to provide an optimum character string placing program in which the above disadvantage is eliminated.

A more specific object of the present invention is to provide an optimum character string placing program for placing character strings more properly and neatly in demarcated regions.

The above objects of the present invention are achieved by an optimum character string placing program that causes a computer to place a character string so as not to overlap another character string in a demarcated region. This program causes the computer to perform horizontal placement to place the character string along a prospective guide line that is located at the center of prospective guide lines that are longer than the longest horizontal segment of the area of the character string, with the prospective guide lines being drawn as imaginary horizontal lines at regular intervals in the demarcated region. Since the prospective guide lines are drawn as imaginary horizontal lines at regular intervals in the demarcated region, and horizontal placement is performed to place the character string along a prospective guide line that is located at the center of prospective guide lines that are longer than the longest horizontal segment of the area of the character string, the region with the prospective guide lines is at least part of the demarcated region that can accommodate the width of the character string, and the region in which the character string can be placed can be promptly determined by selecting the middle one of the prospective guide lines along which the character string can be placed (i.e., the character string cannot be placed in the region with guide lines that are not prospective guide lines). Accordingly, the character string can be promptly placed not only in the case where it can be directly placed but also in the case where fine adjustment needs to be performed vertically and horizontally. In this manner, placement of character strings can be performed far more promptly than in the case where character strings are placed sequentially from the left end of the coordinates in the subject demarcated region. Furthermore, by selecting the middle one of the prospective guide lines, a character string is highly likely to be placed in the center of the subject demarcated region. Thus, neater placement can be realized. The drawing of the guide lines at predetermined intervals is merely an imaginary act, though it is possible to do so actually. In reality, only the distances are calculated. Here, as it is possible to place prospective guide lines at intervals, horizontal placement to place the character string along the prospective guide line located in the middle of continuous guide lines might be preferred. If prospective guide lines are placed at uniform intervals, the prospective guide line located in the middle can be selected based on the distribution of the prospective guide lines (using the deviation value, for example).

The above objects of the present invention are also achieved by an optimum character string placing program that causes a computer to perform tilting placement to diagonally place a character string along the longest demarcated region segment among demarcated region segments that demarcate the demarcated region. Since tilting placement to diagonally place a character string along the longest demarcated region segment among demarcated region segments that demarcate the demarcated region is performed in accordance with the present invention, character strings are placed along the longest demarcated region segment among the demarcated region segments that demarcate the subject demarcated region, and the character strings are likely to be more neatly placed than in a case where character strings are placed along some other demarcated region segment. Also, the neighboring area of the longest demarcated region segment tends to have a large space in the subject demarcated region. Thus, neater placement of character strings can be performed, with ample space being allowed. Furthermore, not only the length of the demarcated region segment is increased but also the formation angle formed by the longest demarcated region segment and the neighboring demarcated region segment is widened, so that the area becomes greater. Therefore, it is preferable to select the longest demarcated region segment.

The above objects of the present invention are also achieved by an optimum character string placing program that causes a computer to perform pull-out placement to place a character string in an adjacent demarcated region in which the longest demarcated region segment among the demarcated region segments that demarcate the demarcated region is located, with the longest demarcated region segment being shared between the demarcated region and a neighboring demarcated region. Since pull-out placement is performed to place a character string in an adjacent demarcated region in which the longest demarcated region segment among the demarcated region segments that demarcate the demarcated region is located, with the longest demarcated region segment being shared between the demarcated region and a neighboring demarcated region in accordance with the present invention, character strings are likely to be placed in an adjacent demarcated region along the longest demarcated region segment among the demarcated region segments, and wider space is likely to be allowed for placing character strings, compared with a neighboring demarcated region of some other demarcated region segment. Thus, character strings can be placed promptly without repetitive placement. Here, character strings are placed in a neighboring demarcated region of the subject demarcated region that shares the longest demarcated region segment. However, it is also possible to place character strings in an adjacent demarcated region in which character strings can be placed, and the adjacent demarcated region is the closest to the subject demarcated region among the adjacent demarcated regions through which the perpendicular line of the longest demarcated region segment in the subject demarcated regions runs. In such a case, character strings are not placed in the neighboring demarcated region, but are placed in adjacent demarcated regions not including the neighboring demarcated region. Therefore, in the above description, character strings are placed not in a neighboring region but in an adjacent demarcated region. Here, the term “adjacent” generally indicates “the vicinity of an object”, and might include “the neighboring area”.

The above optimum character string placing program may cause the computer to perform adjusting placement, so as to move the placed character string vertically or horizontally within the demarcated region. Since adjusting placement to move the placed character string vertically or horizontally within the demarcated region is performed in accordance with the present invention, the character string can be moved even after horizontal placement, tilting placement, or pull-out placement, if there is another character string to be placed, or if the once placed character string should be moved to the center (or the center of gravity).

The above optimum character string placing program may cause the computer to perform centering placement to arrange the placed character string in such a manner that the distances between the demarcated region segments that demarcate the demarcated region and dots on character string region segments that demarcate the character string region are made uniform. Since centering placement is performed to arrange the placed character string in such a manner that the distances between the demarcated region segments that demarcate the demarcated region and dots on character string region segments that demarcate the character string region are made uniform in accordance with the present invention, character strings can be neatly arranged, with uniform distances being maintained from the demarcated region segments, regardless of the shape of the subject demarcated region. Character strings can be neatly arranged in the center of the subject demarcated region by a conventional method, as long as the shape of the subject demarcated region is circular. However, if the shape of the subject demarcated region is not circular, character strings cannot be neatly placed in the center of the subject demarcated region by any conventional method. In accordance with the present invention, the distances from dots on the character string region segments are made uniform, so that character strings can be neatly arranged.

The above objects of the present invention are also achieved by an optimum character string placing program that causes a computer to carry out: a first step of performing the horizontal placement and/or the tilting placement on all demarcated regions; a second step of performing the pull-out placement on each demarcated region in which the horizontal placement and/or the tilting placement cannot be performed in the first step, assuming that the character string placed in the first step has not been placed; and a third step of performing the horizontal placement and/or the tilting placement again to place the character string placed in the first step, and, when the placement cannot be performed because of the character string placed through the pull-out placement in the second step, nullifying the character string placed through the pull-out placement hindering the placement, thereby placing the character string through the horizontal placement and/or the tilting placement. Since a computer is caused to carry out: the first step of performing the horizontal placement and/or the tilting placement on all demarcated regions; the second step of performing the pull-out placement on each demarcated region in which the horizontal placement and/or the tilting placement could not be performed in the first step, assuming that the character string placed in the first step has not been placed; and the third step of performing the horizontal placement and/or the tilting placement again to place the character string placed in the first step, and, when the placement cannot be performed because of the character string placed through the pull-out placement in the second step, nullifying the character string placed through the pull-out placement hindering the placement, thereby placing the character string through the horizontal placement and/or the tilting placement in accordance with the present invention, a demarcated region in which the horizontal placement and/or the tilting placement can be performed is selected in the first step, the pull-out placement is performed in a demarcated region in which the horizontal placement and/or the tilting placement could not be performed while the character string placed in the first step is ignored in the second step, and the character string placed in the first step is placed through the horizontal placement and/or the tilting placement while the character strings placed through the pull-out placement hindering the current placement are nullified in the third step. In this manner, character strings are placed so as to avoid the character strings placed through the pull-out placement. Thus, the greatest possible number of character strings can be placed.

The above optimum character string placing program may cause the computer to perform adjusting placement to move the character string vertically or horizontally within the demarcated region, when the character sting cannot be placed through the first horizontal placement and/or the tilting placement in the third step. In accordance with the present invention, if a character sting cannot be placed through the first horizontal placement and/or the tilting placement in the third step, the character string is moved vertically or horizontally within the subject demarcated region. Accordingly, character strings can be placed through the horizontal placement and/or the tilting placement, without wasting space. Thus, a greater number of character strings can be placed.

The above optimum character string placing program may also cause the computer to perform replacing placement to place alternative display objects such as characters, other character strings, symbols, or graphics, instead of the character string that cannot be placed after the third step. Since replacing placement is performed to place alternative display objects such as characters, other character strings, symbols, or graphics, instead of the character string that cannot be placed after the third step, character strings can be referred to based on the alternative display objects, instead of the character strings that could not be placed through various placing operations after the third step.

The above optimum character string placing program may also cause the computer to perform the pull-out placement again prior to the replacing placement. Since the pull-out placement is again performed prior to the replacing placement, character string placement might be realized with the character string that has been moved after the first pull-out placement. Thus, more preferable character string placement can be realized, without wasting space.

The above optimum character string placing program may also cause the computer to perform centering placement to arrange the already placed character string in such a manner that the distances between demarcated region segments that demarcate the demarcated region and dots on character string region segments that demarcate the character string region are made uniform after the first horizontal placement and/or the tilting placement performed in-the third step. Since centering placement is performed to arrange the already placed character string in such a manner that the distances between demarcated region segments that demarcate the demarcated region and dots on character string region segments that demarcate the character string region are made uniform after the first horizontal placement and/or the tilting placement performed in the third step, character strings can be neatly arranged at least through the horizontal placement and/or the tilting placement, with uniform distances being maintained from demarcated region segments, regardless of the shape of the subject demarcated region. Furthermore, by performing the centering placement after the adjusting placement, character strings are placed through the pull-out placement as many as possible in the subject demarcated region, while the character stings placed through the horizontal placement and/or the tilting placement can be arranged as neatly as possible.

### BRIEF DESCRIPTION OF THE DRAWINGS

Other objects, features and advantages of the present invention will become more apparent from the following detailed description when read in conjunction with the accompanying drawings, in which:

FIGS. 1A through 1C illustrate horizontal placement in accordance with a first embodiment of the present invention;

FIGS. 2A and 2B illustrate tilting placement in accordance with the first embodiment of the present invention;

FIGS. 3A through 3C illustrate pull-out placement in accordance with the first embodiment of the present invention;

FIGS. 4A and 4B illustrate replacing placement in accordance with the first embodiment of the present invention;

FIGS. 5A through 5C illustrate adjusting placement in accordance with the first embodiment of the present invention;

FIGS. 6A through 6C illustrate the adjusting placement in accordance with the first embodiment of the present invention;

FIGS. 7A and 7B illustrate the adjusting placement in accordance with the first embodiment of the present invention;

FIGS. 8A and 8B illustrate centering placement in accordance with the first embodiment of the present invention;

FIG. 9 illustrates the centering placement in accordance with the first embodiment of the present invention;

FIG. 10 is a block diagram of a cadastral information managing system in accordance with the first embodiment of the present invention;

FIG. 11 is a flowchart of the operation of a computer that executes the optimum character string placing program in accordance with the first embodiment of the present invention;

FIG. 12 is a flowchart of the operation of the computer that executes the optimum character string placing program in accordance with the first embodiment of the present invention;

FIG. 13 shows a cadastral map on which the character string placement in accordance with the first embodiment is specifically performed;

FIGS. 14A and 14B illustrate a modification of the pull-out placement in accordance with the first embodiment;

FIGS. 15A and 15B illustrate another modification of the pull-out placement in accordance with the first embodiment;

FIG. 16 illustrates another modification of the adjusting placement in accordance with the first embodiment;

FIG. 17 is a block diagram of a general map display system;

FIG. 18 is a block diagram of a map display system in accordance with another embodiment of the present invention;

FIG. 19 is an example of an output obtained through horizontal placement performed in accordance with yet another embodiment of the present invention;

FIG. 20 is an example of an output obtained through tilting placement performed in accordance with still another embodiment of the present invention; and

FIG. 21 is an example of an output through pull-out placement in accordance with yet another embodiment of the present invention.

### DESCRIPTION OF THE PREFERRED EMBODIMENTS

### First Embodiment

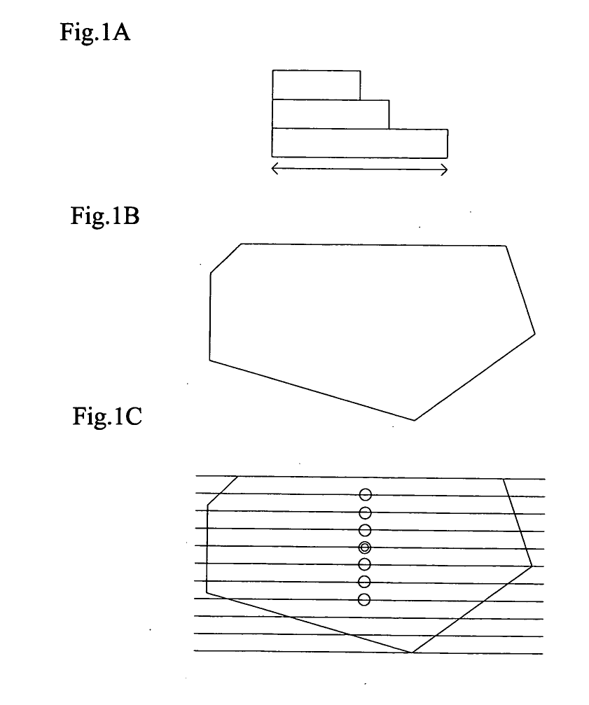

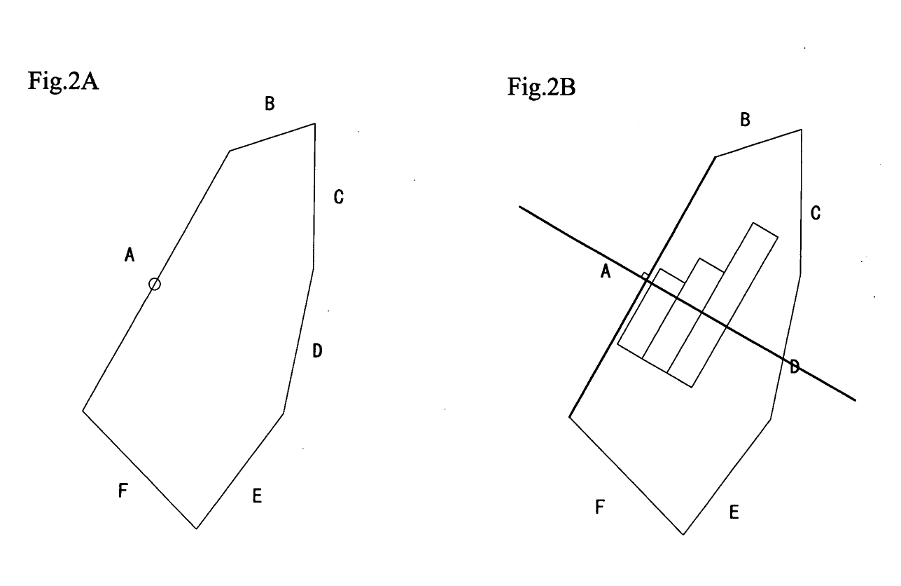

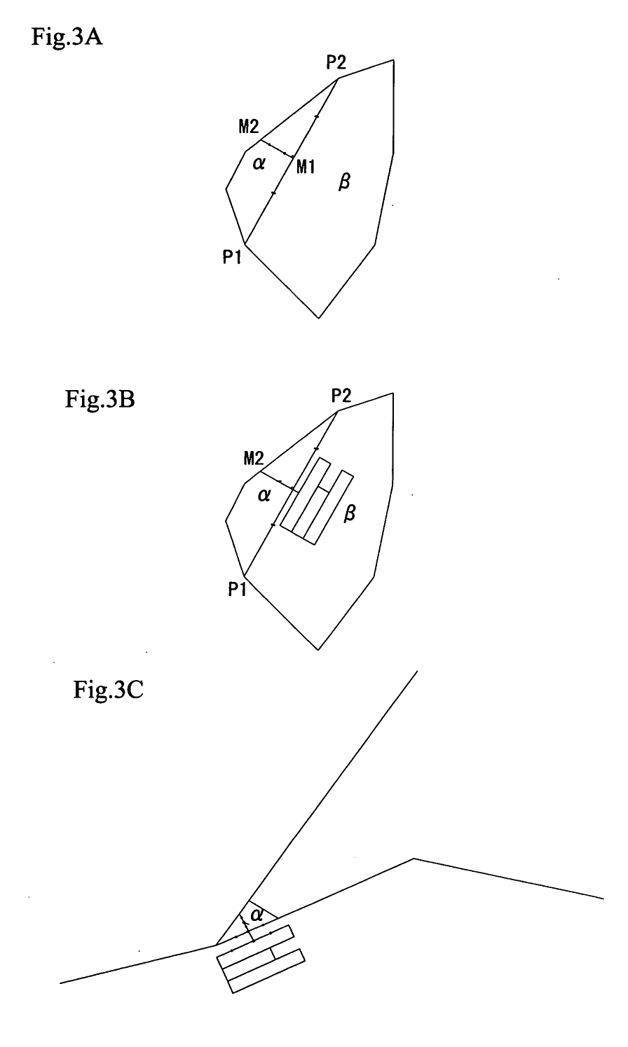

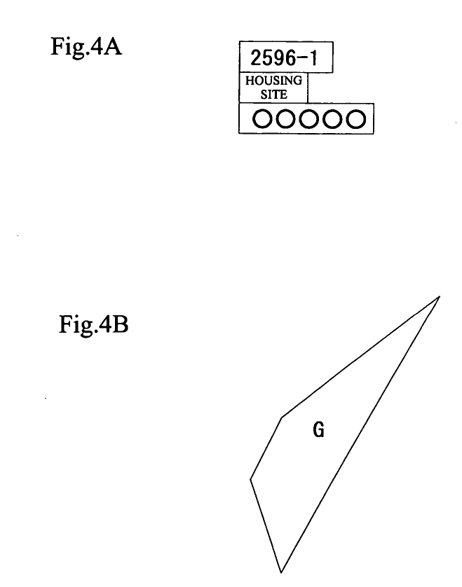

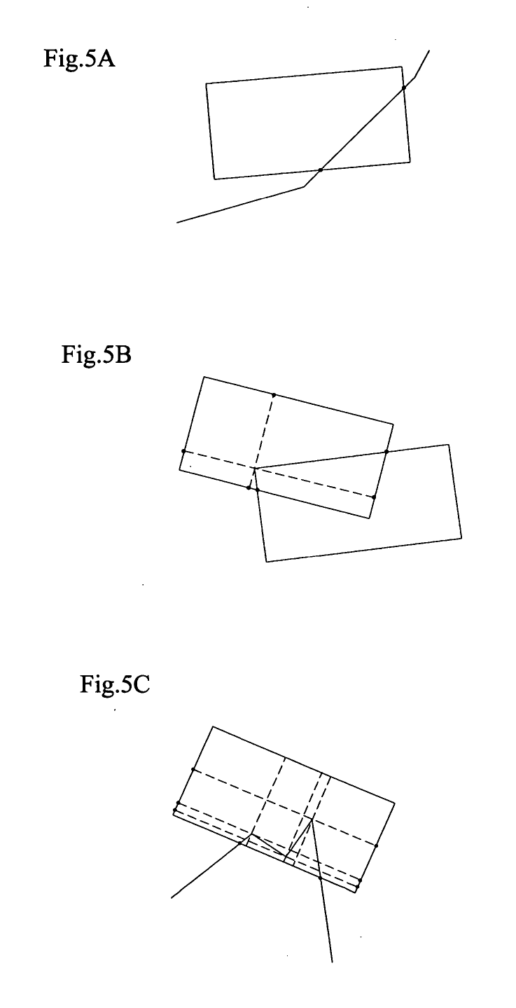

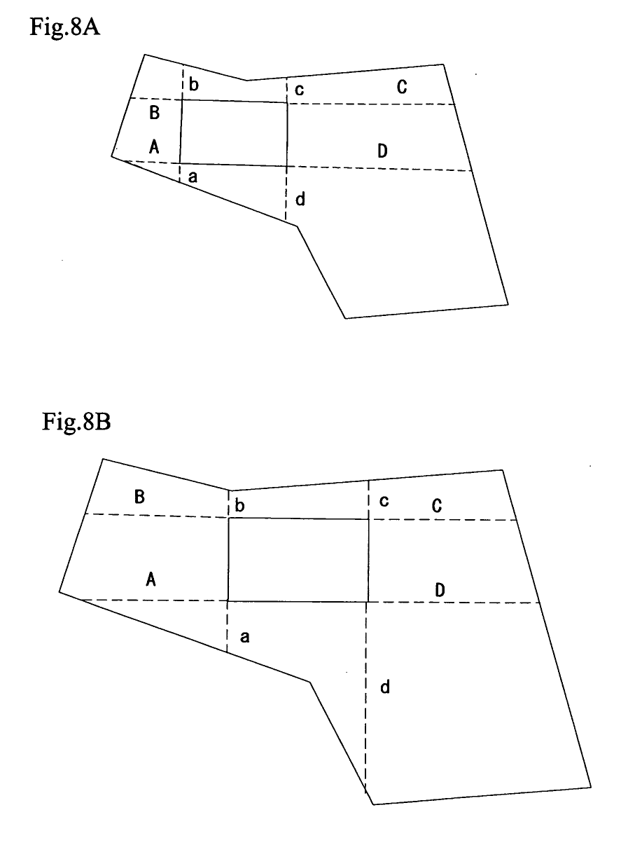

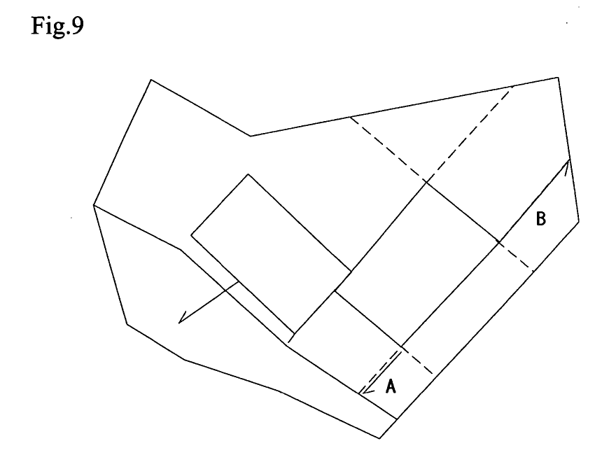

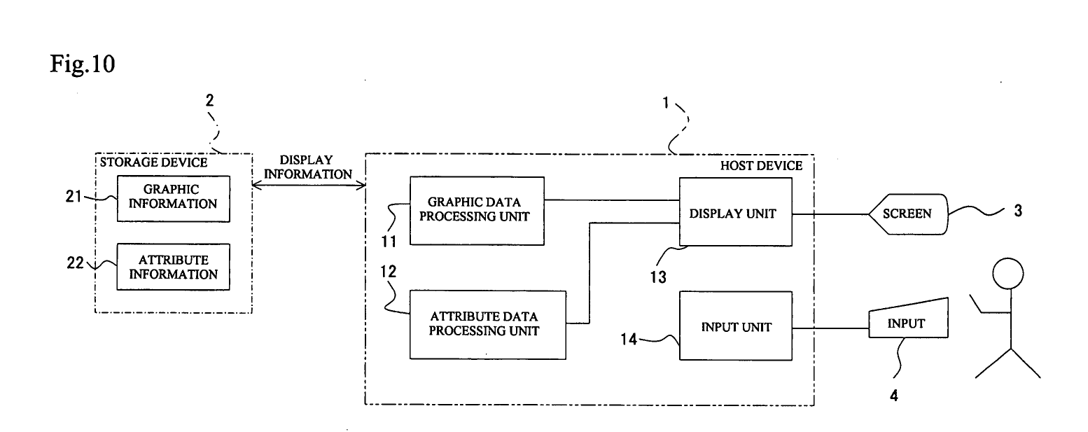

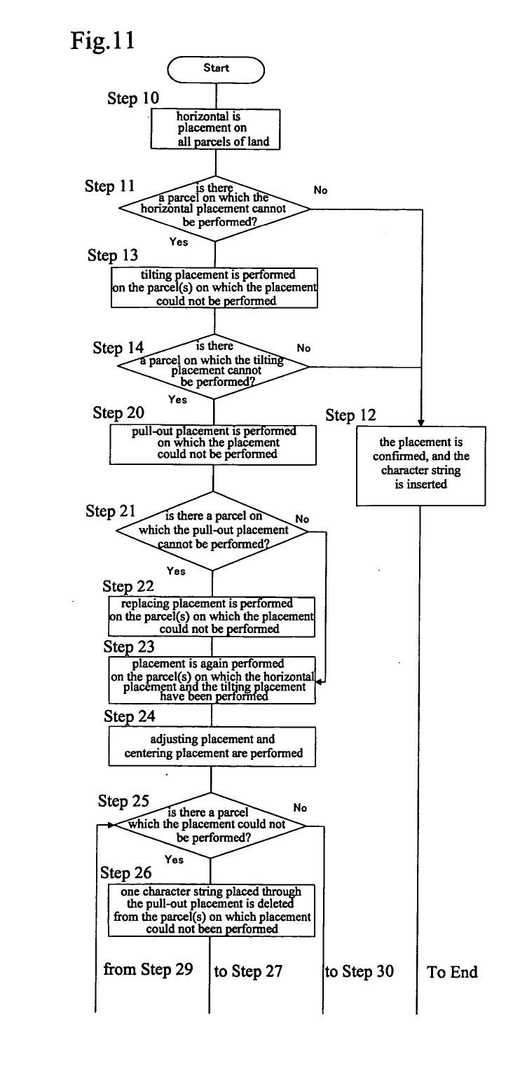

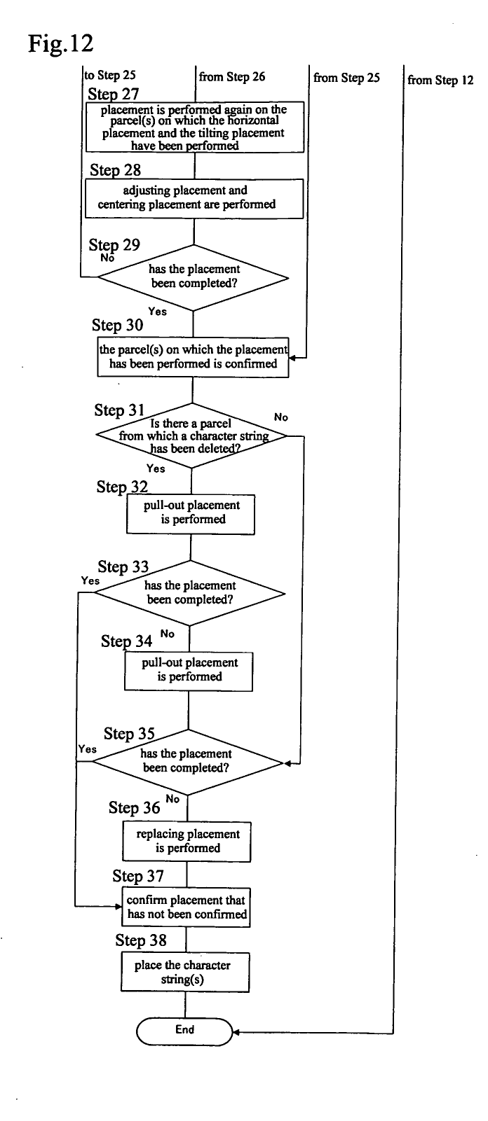

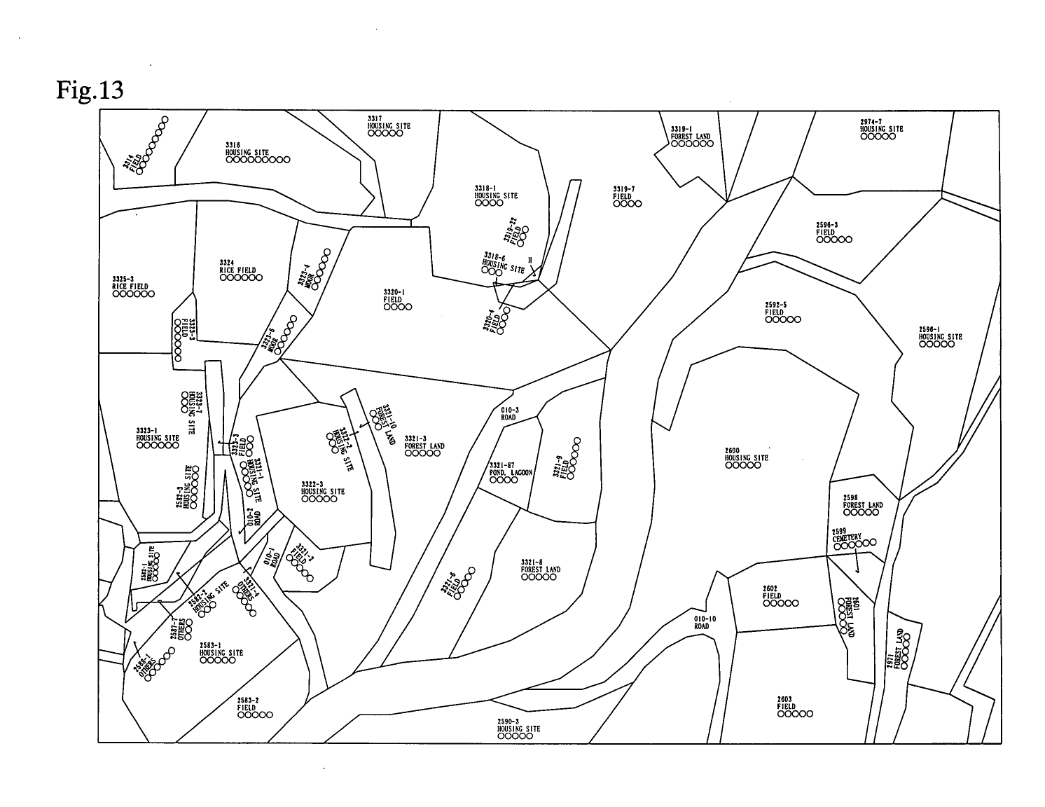

An optimum character string placing program in accordance with a first embodiment of the present invention is described, with reference to FIGS. 1A through 13. FIGS. 1A through 1C illustrate horizontal placement in accordance with this embodiment. FIGS. 2A and 2B illustrate tilting placement in accordance with this embodiment. FIGS. 3A through 3C illustrate pull-out placement in accordance with this embodiment. FIGS. 4A and 4B illustrate replacing placement in accordance with this embodiment. FIGS. 5A through 7B illustrate adjusting placement in accordance with this embodiment. FIGS. 8A and 8B and FIG. 9 illustrate centering placement in accordance with this embodiment. FIG. 10 is a block diagram of a cadastral information managing system in accordance with this embodiment. FIGS. 11 and 12 are flowcharts of the operation of a computer executing the optimum character string placing program in accordance with this embodiment. FIG. 13 is a cadastral map on which character string placement of this embodiment is actually performed.

The optimum character string placing program of this embodiment causes a computer to carry out: a first step of performing the horizontal placement and the tilting placement on all demarcated regions; a second step of performing the pull-out placement on demarcated regions on which the horizontal placement and the tilting placement could not be performed, assuming that character strings placed in the first step have not been placed; a step of performing the replacing placement on character strings that could not be placed in the second step; a third step of placing the character strings, placed in the first step, by again performing the horizontal placement and the tilting placement, performing the adjusting placement to realize the centering placement when necessary, nullifying the character strings that hinders desired placement and have been placed by the pull-out placement in the second step, so as to place the character strings in the horizontal placement and the tilting placement through the pull-out placement; and a step of performing the pull-out placement on character strings that could not be placed after the third step, and performing the replacing placement on the character strings that could not be placed.

In the horizontal placement, guide lines that are virtual horizontal lines are drawn at predetermined intervals in a demarcated region, and a character string is aligned in line with the prospective guide line that is located at the center of the prospective guide lines that are longer guide lines than the longest horizontal line in the character string region. In the case where a character string shown in FIG. 1A (each character is represented by a rectangle, and the character string shown in FIG. 1A consists of three lines) is aligned in a demarcated region shown in FIG. 1B, guide lines are drawn as shown in FIG. 1C, in which each of the longer guide lines than the longest horizontal line is marked by a circle as a prospective guide line. Among the seven prospective guide lines in FIG. 1C, the fourth one from the top is marked by a double circle. The character string is to be placed in line with the prospective guide line marked by the double circle. Here, the center (or the gravity point) of the character string is to be matched with the center point of the prospective guide line, and the prospective guide line is to be regarded as the reference line.

In the tilting placement, the character string is tilted along the longest demarcated region segment among the demarcated region segments that demarcate the demarcated region. As shown in FIGS. 2A and 2B, there are demarcated region segments A, B, C, D, E, and F, and the character string is diagonally placed in line with the longest demarcated region segment A. In other words, the character string is diagonally placed in parallel with the demarcated region segment A.

In the pull-out placement, the character string is placed within a neighboring demarcated region in accordance with the longest demarcated region segment among the demarcated region segments that demarcate the subject demarcated region and the neighboring demarcated region. In FIGS. 3A through 3C, the demarcated region in which the character string is to be placed is denoted by α, and the neighboring demarcated region is denoted by β. The longest demarcated region segment of the demarcated region a is a demarcated region segment P1P2, and the character string is to be placed within the neighboring demarcated region β that shares the demarcated region segment P1P2 with the subject demarcated region α. When the character string is placed in the neighboring demarcated region β, the character string is diagonally placed in parallel with the shared demarcated region segment P1P2. To show that the character string is of the demarcated region α in such a case, the character string is placed near the shared demarcated region segment P1P2, and an extension line is drawn between the demarcated region α and the character string, as shown in FIG. 3B. The end of the extension line in the demarcated region α is located at the center point of the segment by which the vertical line of the longest demarcated region segment is segmented. Alternatively, the end of the extension line may be located at the center or the gravity point of the demarcated region. If the width of the character string is greater than the longest demarcated region segment, as shown in FIG. 3C, the center point of the first line of the character string is matched with the center point of the longest demarcated region segment, and an extension line is drawn from the center point of the vertical line. Instead of the center point of the first line of the character string, the center point of the width of the entire character string may be matched with the center point of the longest demarcated region segment.

In the replacing placement, an alternative to the character string such as characters, another character string, symbols, or drawings is placed in a demarcated region. The character string shown in FIG. 4A cannot be placed in the demarcated region shown in FIG. 4B (the pull-out placement cannot be performed either). Therefore, “G” is displayed as an alternative to the character string. The actual character string may be displayed outside the frame, so that the corresponding character string can be found based on the displayed alternative. In this replacing placement, the horizontal placement and the pull-out placement of the alternative may be performed. The tilting placement may also be performed, but it is not preferred, because it is not clear to the eye in the case of characters.

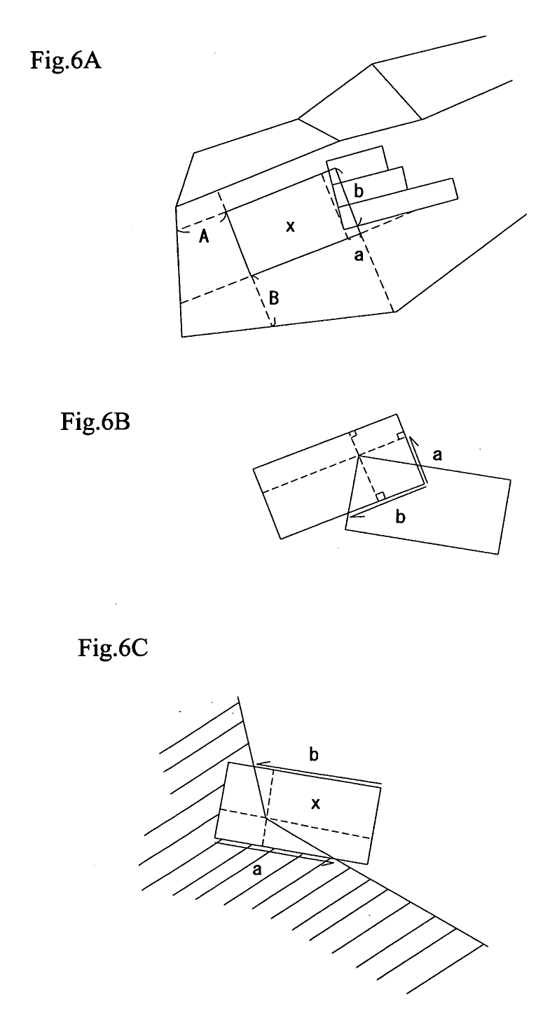

In the adjusting placement, a character string that cannot be placed is moved horizontally or vertically within a demarcated region. Here, the character string that cannot be placed overlaps with a character string that has already been placed or is too big to fit in the demarcated region. Whether a character string can be placed is determined by whether the character string intersects with a segment of another character string or a demarcated region segment (see FIGS. 5A through 5C). If the subject character string intersects with a segment of another character string or a demarcated region segment, the operation illustrated in FIGS. 6A through 6C is performed to realize desired movement. In FIG. 6A, a character string x overlaps with another character string. To eliminate the intersection by displacing the character string x, the character string x should be moved to the left by the amount a (the movable amount on the left side is denoted by A) or should be moved downward by the amount b. It does not matter to choose either, but it is more preferable to choose the greater movement between A-a and B-b. The same applies to the case illustrated in FIG. 6B. In FIG. 6C, the operation differs between the case where the character string x is to be placed in the shaded area and the case where the character string x is to be moved out of the shaded area. To move the character string x out of the shaded area, the character string x should be moved to the left by the amount a. To place the character string x in the shaded area, the character string x should be moved by the amount b. However, these movements can be made-only if there are movement margins on both sides.

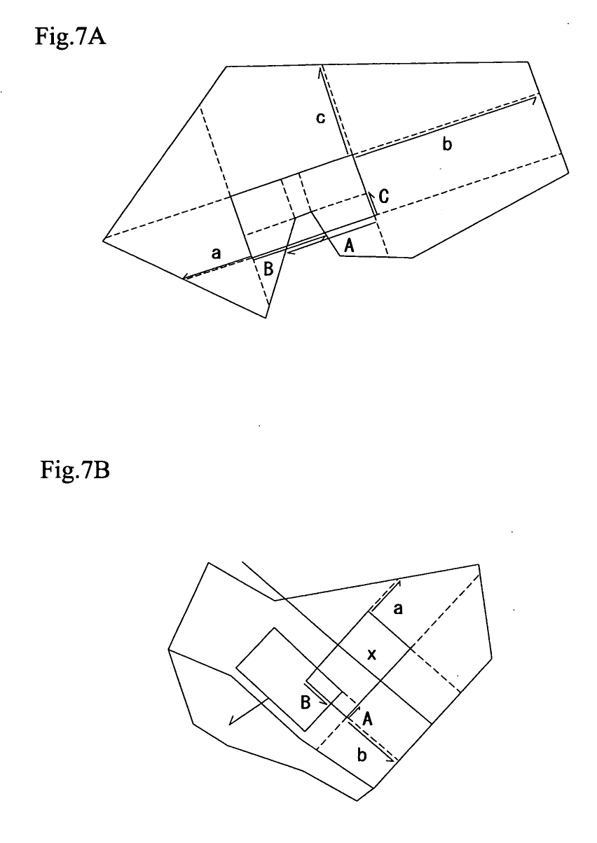

In the case where a character string is to be placed in a demarcated region having a concavity and the character string is located over the concavity, as shown in FIG. 7A, the character string cannot be moved to the left, because the length A is greater than the length a. In the same case, the character string can be moved, because the length B is smaller than the length b. Likewise, the character string can be moved, because the length C is smaller than the length c. The one with the greater movement margin is selected so that the character string can be prevented from intersecting with a segment of another character string or a segment of the demarcated region with a high probability. In the case where a character string has been already placed through pull-out placement in a demarcated region and another character string overlaps the character string placed through the pull-out placement, as shown in FIG. 7B, the character string can be moved to the right, because the length a is greater than the length A. In the same case, the character string can be moved downward, because the length b is greater than the length B. Here, the distance a-A is smaller than the distance b-B, and therefore, the character string should be moved downward, so that the character string can be prevented from intersecting with a segment of another character string with a high probability. It is possible to move the character string by all movable amount, but it is also possible to move the character string step by step. The latter manner is more preferable because the character string might be prevented from intersecting with another character string by a small movement. Also, it is possible to move the character string by performing feedback of the intersection every time a movement is made.

In the centering placement, character string placement is performed so that the distances between the demarcated region segments that demarcate the demarcated-regions and the points on the character string region segments that demarcate the character string regions can be made uniform. The points on the character string region segments are predetermined points. As the precision varies depending on the setting of the predetermined points, the predetermined points should preferably be determined in accordance with the shape of the demarcated region. However, the predetermined points in this embodiment are the four corners of the demarcated region. In such a case, the normal line distances between a certain point and the closest demarcated region segments or the closest character string segments. The location at which the distances become most uniform is detected, and the character string is placed in the centering placement. More specifically, in the case where a character string concentrates on one demarcated region, as shown in FIG. 8A, the region C is employed as the region C is smaller than the region D, the region A is employed as the region A is smaller than the region B, the region c is employed as the region b is greater than the region c, and the region a is employed as the region a is smaller than the region d. Further, the region C that is equivalent to the right-side movement amount is greater than the region A that is equivalent to the left-side movement amount, and the mean value is determined by (C-A)/2.0. The character string is moved to the right by the mean value in accordance with the first method. Meanwhile, the region c that is equivalent to the upward movement amount is greater than the region a that is equivalent to the downward movement amount, and the mean value is determined by (c-a)/2.0. The character string is moved upward by the amount represented by the mean value in accordance with the second method. Since the movement amount is greater in accordance with the first method, the first method is employed to move the character string. In the case where a character string concentrates on one demarcated region, as shown in FIG. 8B, the regions C, A, b, and a are selected in the same manner as in the case illustrated in FIG. 8A. Since the region C and the region A represent the same movement amount, the mean value is determined by (a-b)/2.0 as the region a that is equivalent to the downward movement amount a is greater than the region b that is equivalent to the upward movement amount. The character string is moved by the amount represented by the mean value. FIG. 9 illustrates a movement through tilting placement. In this case, the movement is made in the same manner as in the cases illustrated in FIGS. 8A and 8B, except that the movement is not in the vertical direction or in the horizontal direction. It is also possible to perform the centering placement in accordance with the area of the region surrounded by the demarcated region segments, the vertical line, and the horizontal line.

The operation of a computer that executes the optimum character string placing program in accordance with this embodiment is described below, taking the case of applying the optimum character string placing program to a cadastral information managing system as an example. As shown in FIG. 10, the essential components of the cadastral information managing system include: a storage device 2 that stores graphic information 21 and attribute information 22; an operating device 1 that includes a graphic data processing unit 11, an attribute data processing unit 12, a display unit 13, and an input unit 14; a display screen 3; and an input device 4. The graphic data processing unit 11 reads the graphic information 21 out of the storage device 2 and processes the graphic information 21. The attribute data processing unit 12 reads the attribute information 22 out of the storage device 2 and processes the attribute information 22. The display unit 13 displays the geographical information processed by the graphic data processing unit 11 and the attribute data processing unit 12 on the display screen 3. The input unit 14 receives inputs from the input device 4. In this structure, the attribute data processing unit 12 is enhanced to realize the functions of the optimum character string placing program (or an optimum character string placing unit may be employed separately). The attributes of additional attribute information include location, lot number, land sections (parcels of land, unidentified land, unnumbered long lot, lost lot), registered land category, taxable land category, registered area, taxable area, calculated area, owner information, co-owner information, tax payer, administrator, management of non-registered land, management of unidentified land, cadastral map number, scale and accuracy, registered date, title to the land, type of land usage, and items that can be managed separately (such as remarks). In the operation of the cadastral information managing system, the input unit 14 receives an input from the input device of a user, the graphic data processing unit 11 or the attribute data processing unit 12 reads the graphic information 21 or the attribute information 22 from the storage device 2 in accordance with the input, the read information is then output to the display unit 13, and the display unit then displays the information on the screen 3. This cadastral information managing system can have the function of editing the graphic data 21 or the attribute data 22. If the land changes hands, the graphic data 21 or the attribute data 22 can be changed accordingly. When the graphic data 21 is changed, land assembling is performed to combine parcels of land, or land dividing is performed to divide a land. Such a change can be made by handling a mouse, inputting coordinates, designating the land lot number, performing a write operation in an external file, or retrieving a raster image and tracing it through a mouse operation. Not only to output information onto the screen 3, it is also possible to output information as a print output such as a drawing or a ledger sheet, or information that has bee converted into a different data format. However, the present invention can be applied not only to a cadastral information managing system, but also to a system that requires the function of placing a character string in a demarcated region.

When a character string cannot be placed, a character string region segment intersects with another character string region segment or a demarcated region segment. Therefore, it is necessary to promptly determine whether there is a character string region segment that intersects with another segment. Here, the determination should be made not only at a high speed but also with efficient use of hardware resources. Therefore, it is not preferable to determine whether character string region segments intersects with each other through a simple segment search based on the coordinates from the top. It is more preferable to employ a gap search using a tree quartering method. More preferably, with a map having two or more demarcated regions, the map (first-level map) is divided into four maps (the upper-left second-level map, the upper-right second-level map, the lower-left second-level map, and the lower-right second-level map), and the demarcated region that does not fall into any of the divided regions is regarded as a first-level demarcated region and is registered in association with the first-level map. Each of the divided maps is further divided into four maps, and the demarcated region that does not fall into any of the divided regions is regarded as the second-level demarcated region and is registered in association with the corresponding second-level map. Likewise, the n-level maps are formed to obtain the n-level demarcated region, which is registered in association with the n-level map. In this manner, inference base are formed, and, when a search is carried out, which level the segment to be searched belongs to is determined, starting from the first-level map (this search operation is the same as a search operation in accordance with a search tree). For example, in a case where the subject segment belong to the upper-left third-level map obtained by dividing the upper-left second-level map but does not belong to any fourth-level map, this fact is determined in four steps, and the relations with other regions can be detected from the coordinates in the restricted regions. Thus, a high-speed operation can be expected. Also, there is a case a demarcated region (an inner demarcated region) exists in a demarcated region. In such a case, the relationship between the demarcated regions is recorded, and, when a character string is placed in the demarcated region, the recorded information is referred to. Strictly speaking, such an inner demarcated region is not a demarcated region, a character string cannot be placed in the inner demarcated region. Therefore, without the recorded information, wrong placement might be performed. However, it is also necessary to pay attention to the fact that pull-out placement can be performed in an inner demarcated region. A specific example of good-looking character string placement is a case where a character string is placed in an inner demarcated region that exists in a demarcated region having approximately the same size as the inner demarcated region. In such a case, the character string can be neatly placed in the center of the demarcated region. Closer attention should be paid to a case where an inner demarcated region exists in an inner demarcated region.

In the following, the actual operation of a computer that executes the optimum character string placing program is described. First, the attribute data processing unit 12 (hereinafter, each step is carried out by the attribute data processing unit 12, unless otherwise mentioned) places a character string horizontally with respect to all the parcels of land (Step 10). The attribute data processing unit 12 determines whether there is a parcel of land on which horizontal placement of a character string cannot be performed (Step 11). If there is not a parcel of land on which horizontal placement cannot be performed, a character string is placed (step 12), and the operation ends (only the function of the optimum character string placing program ends; display on the screen 3 is performed later). If there is a parcel of land on which horizontal placement cannot be performed, tilting placement is performed on the parcel in which the character string could not be placed (Step 13). The attribute data processing unit 12 determines whether there is a parcel of land on which tilting placement of a character string cannot be performed (Step 14). If there is not a parcel of land on which tilting placement cannot be performed, the operation moves on to Step 12. If the attribute data processing unit 12 determines that there is a parcel in which the character string cannot be placed through tilting placement in Step 14, pull-out placement is performed to place the character string in the parcel on which the tilting placement could not be performed (Step 20). The attribute data processing unit 12 determines whether there is a parcel of land in which a character string cannot be placed through pull-out placement (Step 21). If there is a parcel in which the character string cannot be placed through pull-out placement, replacing placement is performed on the parcel in which the character string could not be placed (Step 22). Horizontal placement and tilting placement are then performed on the parcel(s) in which character strings were placed through the horizontal placement and the tilting placement in Step 10 or Step 13 (Step 23). Adjusting placement is then performed, and centering placement is further performed (Step 24). The attribute data processing unit 12 then determines whether there is a parcel of land in which a character string could not be placed in Step 23 or Step 24 (Step 25). If there is a parcel in which a character string could not be placed, one character string placed through pull-out placement is deleted from the parcel in which placement could not be performed (Step 26). After the deletion, placement is retried (Step 27). Adjusting placement is then performed, followed by centering placement (Step 28). The attribute data processing unit 12 determines whether a character string was placed through the deletion (Step 29). If the attribute data processing unit 12 determines that the character string could not be placed, the operation moves on to Step 26. If the attribute data processing unit 12 determines that the character string was placed in Step 29, the operation moves on to Step 25. If the attribute data processing unit 12 determines in Step 25 that there is not a parcel of land in which a character string cannot be placed, the attribute data processing unit 12 confirms the parcels of land in which character strings were placed (Step 30). The attribute data processing unit 12 then determines whether there is a parcel of land from which a character string has been deleted (Step 31). If there is not a parcel of land from which a character string has been deleted, the operation moves on to Step 33. If the attribute data processing unit 12 determines in Step 31 that there is a parcel of land from which a character string has been deleted, pull-out placement is performed (Step 32). The attribute data processing unit 12 then determines whether the pull-out placement has been performed (Step 33). If the attribute data processing unit 12 determines that the pull-out placement has been performed, the operation moves on to Step 37. If the attribute data processing unit 12 determines in Step 33 that the placement cannot be performed, the pull-out placement is retried (Step 34). The attribute data processing unit 12 then determines whether the pull-out placement has been performed (Step 35). If the attribute data processing unit 12 determines that the placement has been performed, the operation moves on to Step 37. If the attribute data processing unit 12 determines in Step 35 that the placement cannot be performed, the character string is placed through replacing placement (Step 36). The attribute data processing unit 12 confirms that unconfirmed character strings have been placed (Step 37). Lastly, the attribute data processing unit 12 actually places the character strings (Step 38).

In the above described manner, the optimum character string placing program in accordance with this embodiment causes a computer to execute: the first step of performing horizontal placement and tilting placement on all the demarcated regions; the second step of performing pull-out placement on the demarcated region(s) in which the character string has not been placed through the horizontal placement and the tilting placement in the first step, assuming that the character string placed in the first step has not been placed; and the third step of performing horizontal placement and tilting placement again to place the character string placed in the first step, and if the character string placed through the pull-out placement in the second step hinders the placement, nullifying the placement of the character string hindering the placement in this step, and then placing the character string through the horizontal placement and the tilting placement. In the first step, each demarcated region in which horizontal placement and tilting placement can be performed can be selected. In the second step, pull-out placement is performed on the demarcated region(s) on which the horizontal placement and the tilting placement could not be performed, while the character string placed in the first step is ignored. In the third step, the character string placed in the first step is again placed through horizontal placement and tilting placement, and the character string that has been placed through the pull-out placement and hinders the placement is nullified. In this manner, the character string to be placed through horizontal placement and/or tilting placement can avoid the character string placed through the pull-out placement. Thus, it is possible to place as many character strings as possible. After the third step, replacing placement to place alternatives to the character string, such as characters, other character strings, symbols, or graphics, is performed on the demarcated regions in which a character string could not be placed. Accordingly, alternatives to the character strings that could not be placed through the placing operations after the second step are placed, and, based on those alternatives, a character string can be searched for. Also, in the third step, after the horizontal placement and the tinting placement, the centering placement is performed on the placed character string so that the distances between the demarcated region segments that demarcate the demarcated region and the character string region segments that demarcate the character string regions can be made uniform. In this manner, the character string is placed at uniform distances from all the dots on the character string region segments. Thus, character strings can be neatly placed at least through horizontal placement and tilting placement at uniform distances from the demarcated region segments, regardless of the shape of the subject demarcated region. Further, after the centering placement, adjusting placement is performed so that the character string placed through horizontal placement and tilting placement can be arranged as neatly as possible, while the character string placed through pull-out placement can be placed in the demarcated region. When the first horizontal placement and the tilting placement cannot be performed in the third step, the character string that cannot be placed is moved horizontally and vertically within the demarcated region. By doing so, the character string placed through the horizontal placement and the tilting placement can be arranged in such a manner as not to waste space. Thus, it becomes possible to place as many character strings as possible.

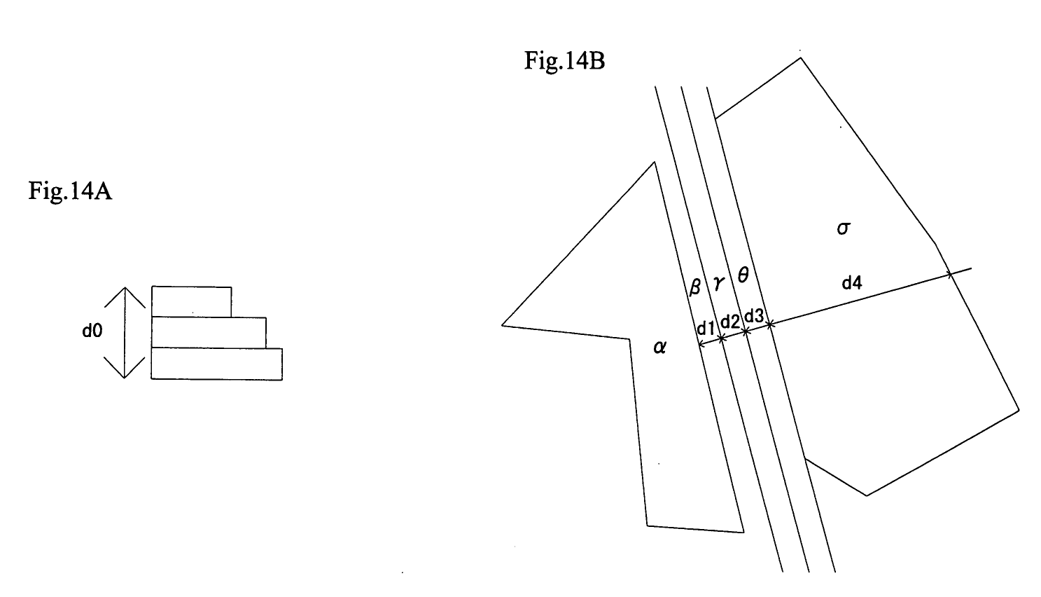

The pull-out placement in accordance with this embodiment is performed to place a character string in a demarcated region that shares the longest demarcated region segment with the subject demarcated region. However, a character string can be placed in one of the neighboring demarcated regions through which the vertical line of the longest demarcated region segment of the subject demarcated region. The one of the neighboring demarcated regions is the closest to the subject demarcated region. In this manner, a character string can be placed not only in a neighboring demarcated region of the subject demarcated region but also in a demarcated region neighboring to the neighboring demarcated regions of the subject demarcated region. More specifically, in the case where the neighboring demarcated region is an unnumbered long lot such as a river or a road, a character string can be placed in a demarcated region neighboring to the neighboring demarcated region. Referring now to FIGS. 14A and 14B, a specific example is described. As the character string shown in FIG. 14A cannot be placed in a demarcated region α, pull-out placement is performed. To do so, the height d0 of the character string region is calculated, and the distances (d1, d2, d3, and d4) of the segments obtained by the adjacent demarcated regions dividing the vertical line. Each of the distances is compared with the length d0 (see FIG. 14B), and the adjacent demarcated region a that has a greater segment than d0 is selected. The character string is then placed in the adjacent demarcated region a. Through this operation, a character string can be neatly arranged in the case where unnumbered long lots exist as neighboring demarcated regions.

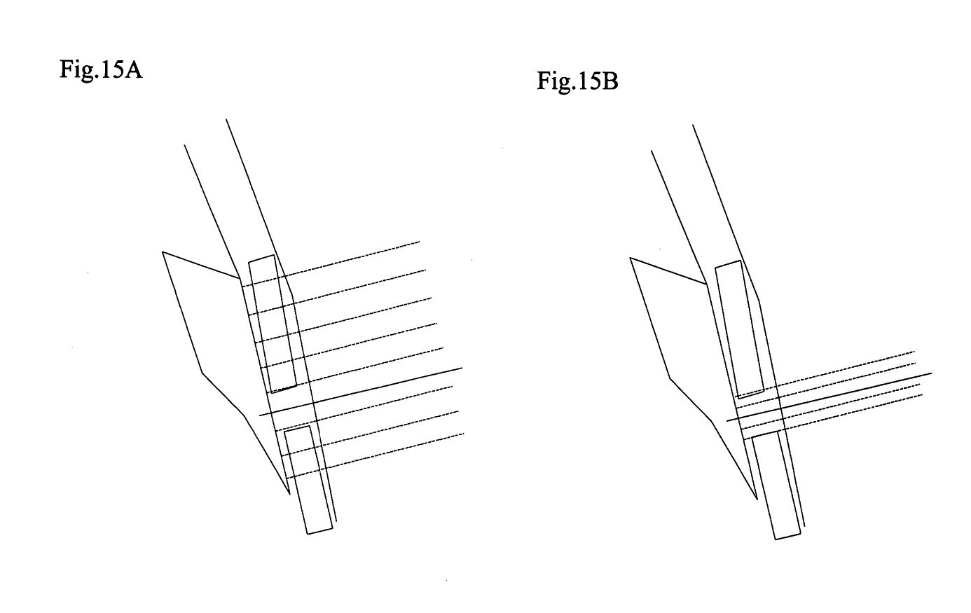

In the pull-out placement in accordance with this embodiment, the vertical line of the longest demarcated region segment is used to place a character string in an adjacent demarcated region. However, it is also possible to use a vertical line that passes through another dot, instead of the center point, on the longest demarcated region segment. By doing so, the pull-out placement can be performed to avoid the character string that has already been placed in a neighboring demarcated region or an adjacent demarcated region. In such a case, which point on the demarcated region segment the vertical point passes through becomes an important factor. However, it is possible to arrange a character string, while the vertical line is set to pass through all the dots, starting from an end, or while the vertical line is caused to pass through dots arranged at regular intervals (see FIG. 15A). It is also possible to cause the vertical line to pass through both ends alternately. Further, the vertical line may be drawn from a peripheral area in which a gap is supposed to form based on the coordinates of the character string placed in a neighboring demarcated region (see FIG. 15B). In such a case, there is no need to draw a vertical line in other areas, and a more efficient operation can be performed accordingly.

In the pull-out placement in accordance with this embodiment, a character string is to be placed in a neighboring demarcated region that shares the longest demarcated region segment with the subject demarcated region. However, it is also possible to place a character string in a neighboring demarcated region that shares another demarcated region segment with the subject demarcated region. In such a case, the character string is placed in the neighboring demarcated region that would leave a greater margin after the character string is placed. By placing the character string in the neighboring demarcated region with the greater margin, the possibility of deletion can be reduced in the case where the horizontal placement and the tilting placement are performed in Step 27.

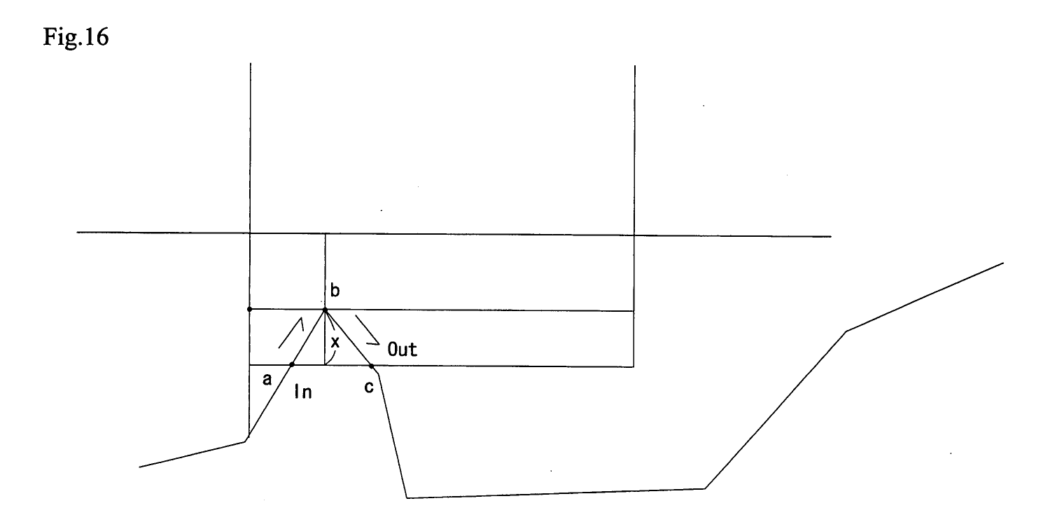

The adjusting placement in accordance with this embodiment is performed to move a character string along the longest line of the vertical lines and horizontal lines that are drawn vertically and horizontally from the four corners of the character string. In the case where a character string intersects with a segment as shown in FIG. 16, or where a character string interests with a corner (the point b) formed by demarcated region segments, the character string is moved away from the corner to avoid the intersection. The shape of the overlapped portion is detected to determine how the character string intersects with the corner. After the intersection of the character string with the corner is determined, the character string is moved upward from the top point b of the corner by a distance x. Thus, the intersecting situation is cancelled. In the case illustrated in FIG. 16, the lower part of the character string intersects with the corner portion. Therefore, the character string should be moved up.

The replacing placement in accordance with this embodiment is performed to place alternative display objects in a horizontal manner. However, horizontal placement, pull-out placement, and centering placement can also be performed on the alternative display objects. Thus, the alternative display objects can also be neatly arranged.

The operation of a computer that executes the optimum character string placing program in accordance with this embodiment is shown in the flowchart of FIGS. 11 and 12. However, it is possible to omit the replacing placement of Step 22, and temporarily store the parcel on which the pull-out placement could not be performed. In Step 31, the attribute data processing unit 12 may determine whether there is a parcel on which placement cannot be performed, and, if there is a parcel on which placement cannot be performed, the attribute data processing unit 12 performs pull-out placement (Step 32). After that, the computer can be set to perform the same operations. In this manner, replacing placement is performed lastly, so that character strings can be displayed only through horizontal placement, tilting placement, and pull-out placement.

### Other Embodiments

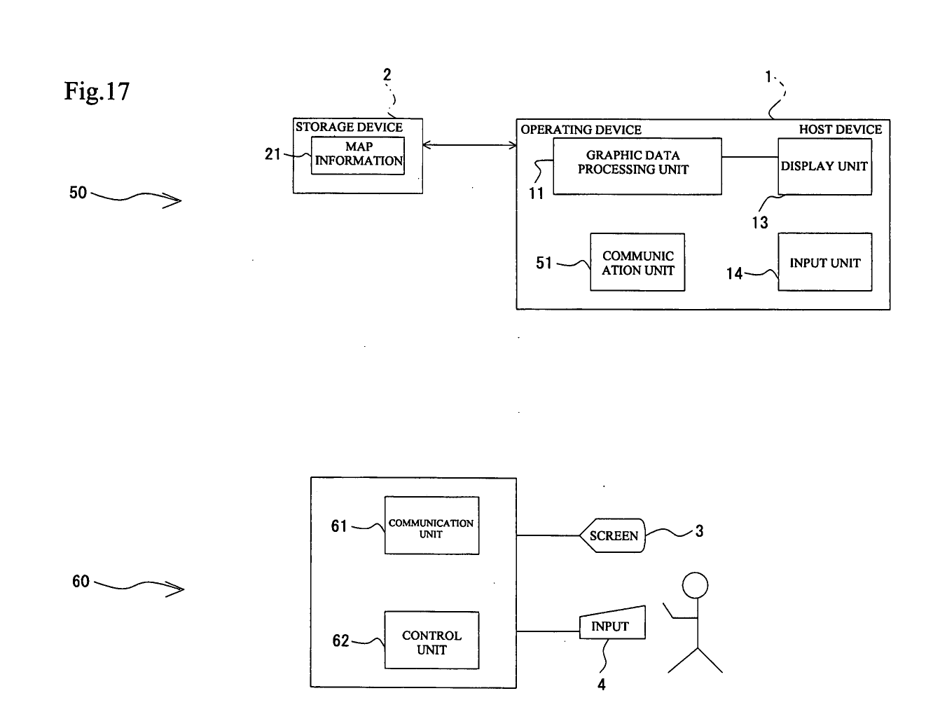

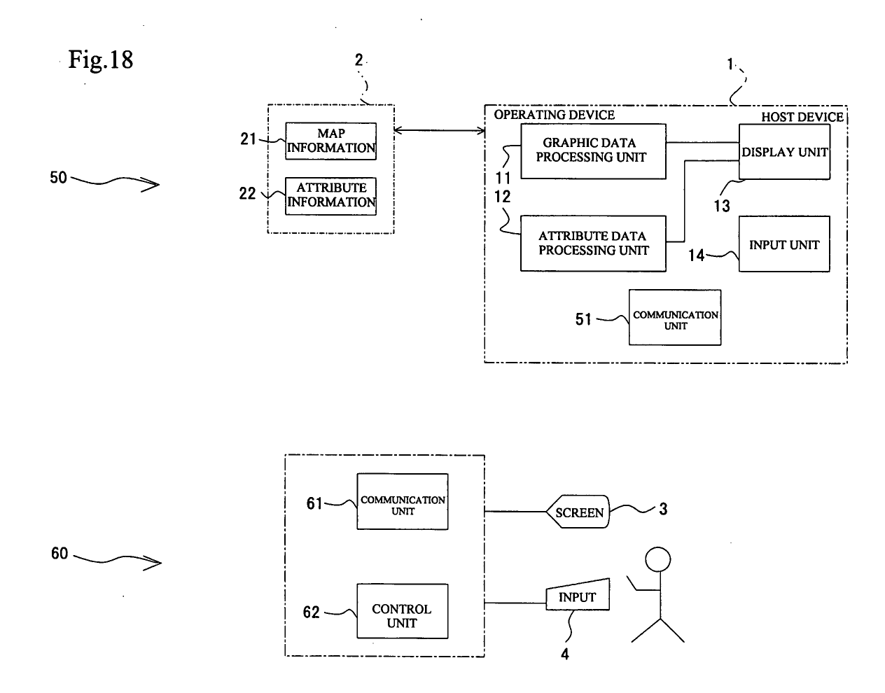

Although the optimum character string placing program in accordance with the first embodiment is applied to a cadastral information managing system, it may be applied to a map display system of a server-client type that is used through the Internet. In a map display system of a server-client type that is widely used through the Internet, part of colored map data that contain map symbols and character strings such as addresses, names of intersections, and names of buildings on the server is transmitted to a display device on the client side (see FIG. 17). At the ends of the map on display, there is a problem that the character strings and the map symbols are only partially displayed. Therefore, apart from the map information 21, at least the character strings such as the addresses, the names of intersection, and the names of buildings, are stored as attribute information 22 in the storage device 2, and the attribute data processing unit 12 to process the data of the attribute information is employed (a optimum character string processing unit may be employed, instead of the attribute data processing unit 12), as shown in FIG. 18. The operation of the computer that executes the optimum character string placing program is substantially the same as the operation in accordance with the first embodiment, except that character strings are placed also in demarcated regions that are demarcated by the display frame and demarcated region segments. In accordance with the optimum character string placing program in accordance with the first embodiment, the data at the end portions of the display area is only partially displayed. In this embodiment, on the other hand, character strings are placed in the displayed demarcated regions even at the end portions in the display area. Thus, more smooth and effective display can be realized.

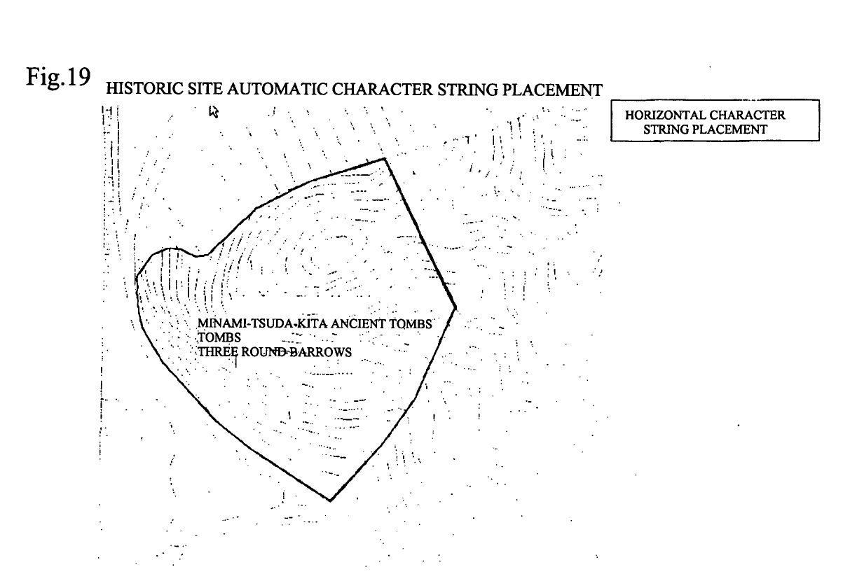

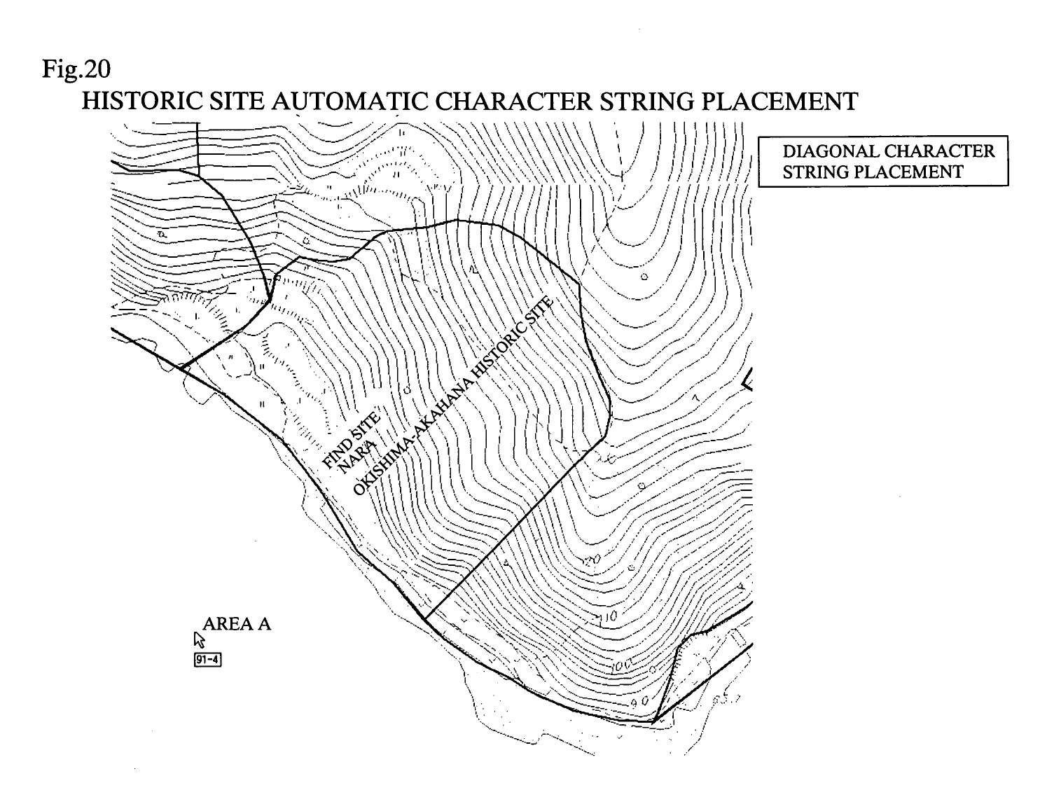

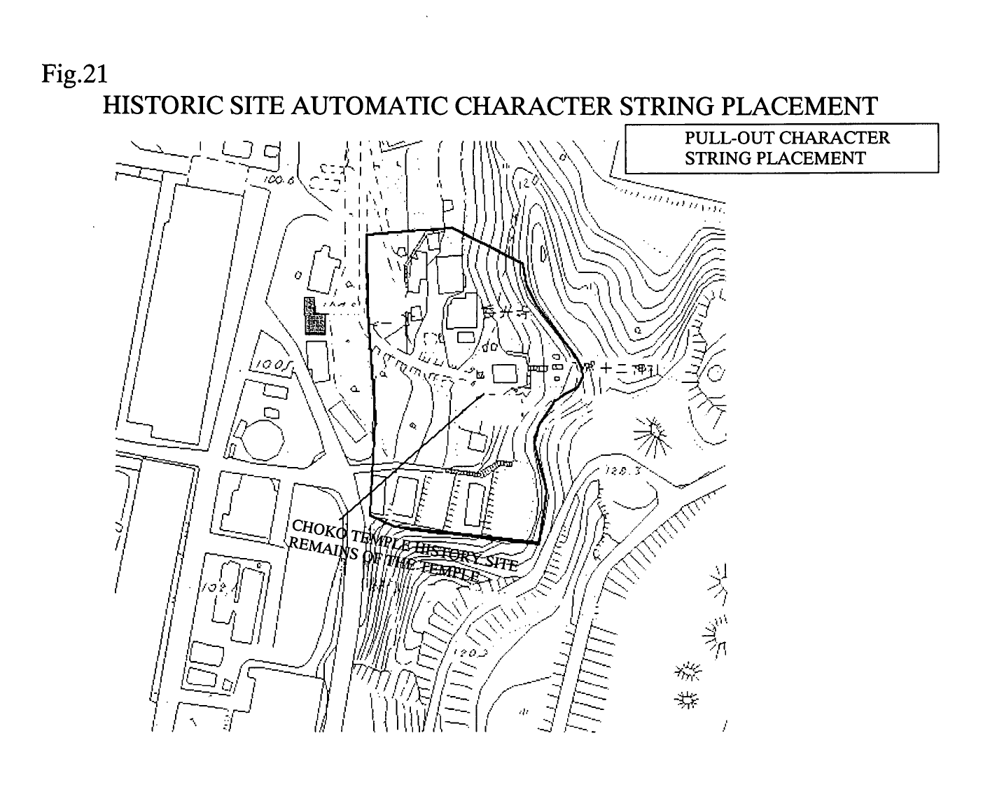

Although the optimum character string placing program in accordance with the first embodiment is applied to a cadastral information managing system, it may be applied to another system. For example, the optimum character string placing program may be applied to a system for managing information as to ancient burial mounds. Examples of maps that are output from such a system are shown in FIGS. 19 through 21. In those drawings, tilting character string placement may be referred to as diagonal character string placement.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An optimum character string placing program that causes a computer to place a character string so as not to overlap another character string in a demarcated region,
the program causing the computer to:
perform horizontal placement to place the character string along a prospective guide line that is located at the center of prospective guide lines that are longer than the longest horizontal segment of the area of the character string, the prospective guide lines being drawn as virtual horizontal lines at regular intervals in the demarcated region.

2. An optimum character string placing program that causes a computer to place a character string so as not to overlap another character string in a demarcated region,
the program causing the computer to:
perform tilting placement to diagonally place the character string along the longest demarcated region segment among demarcated region segments that demarcate the demarcated region.

3. An optimum character string placing program that causes a computer to place a character string so as not to overlap another character string in a demarcated region,
the program causing the computer to:
perform pull-out placement to place the character string in an adjacent demarcated region in which the longest demarcated region segment among the demarcated region segments that demarcate the demarcated region is located, the longest demarcated region segment being shared between the demarcated region and a neighboring demarcated region.

4. The optimum character string placing program as claimed in claim 1, wherein the computer is caused to perform adjusting placement to move the placed character string vertically or horizontally within the demarcated region.

5. The optimum character string placing program as claimed in claim 1, wherein the computer is caused to perform centering placement to arrange the placed character string in such a manner that the distances between the demarcated region segments that demarcate the demarcated region and dots on character string region segments that demarcate the character string region are made uniform.

6. An optimum character string placing program that causes a computer to perform horizontal placement, tilting placement, and pull-out placement,
the horizontal placement being performed to place a character string along a prospective guide line that is located at the center of prospective guide lines that are longer than the longest horizontal segment of the area of the character string, the prospective guide lines being drawn as virtual horizontal lines at regular intervals in a demarcated region,
the tilting placement being performed to diagonally place the character string along the longest demarcated region segment among demarcated region segments that demarcate the demarcated region,
the pull-out placement being performed to place the character string in an adjacent demarcated region in which the longest demarcated region segment among the demarcated region segments that demarcate the demarcated region is located, the longest demarcated region segment being shared between the demarcated region and a neighboring demarcated region,
the program causing the computer to carry out:
a first step for performing the horizontal placement and/or the tilting placement on all demarcated regions;
a second step for performing the pull-out placement on each demarcated region in which the horizontal placement and/or the tilting placement cannot be performed in the first step, assuming that the character string placed in the first step has not been placed;
a third step for performing the horizontal placement and/or the tilting placement again to place the character string placed in the first step, and, when the placement cannot be performed because of the character string placed through the pull-out placement in the second step, nullifying the character string placed through the pull-out placement hindering the placement, thereby placing the character string through the horizontal placement and/or the tilting placement.

7. The optimum character string placing program as claimed in claim 6, wherein the computer is caused to perform adjusting placement to move the character string vertically or horizontally within the demarcated region, when the character sting cannot be placed through the first horizontal placement and/or the tilting placement in the third step.

8. The optimum character string placing program as claimed in claim 6, wherein the computer is caused to perform replacing placement, after the third step, to place alternative display objects such as characters, other character strings, symbols, or graphics, instead of the character string that cannot be placed in the first through third steps.

9. The optimum character string placing program as claimed in claim 8, wherein the computer is caused to perform the pull-out placement again prior to the replacing placement.

10. The optimum character string placing program as claimed in claim 6, wherein the computer is caused to perform centering placement to arrange the already placed character string in such a manner that the distances between demarcated region segments that demarcate the demarcated region-and dots on character string region segments that demarcates the character string region are made uniform, after the first horizontal placement and/or the tilting placement in the third step.
